(19) United States
(12) Patent Application Publication
(10) Pub. No.: US 2018/0322574 A1
(43) Pub. Date: Nov. 8, 2018

(54) RISK-CONTROL-BASED QUANTITATIVE TREND TRANSACTION DECISION-MAKING SYSTEM AND METHOD

(71) Applicant: Qing MIAO, Taiyuan City (CN)

(72) Inventor: Qing MIAO, Taiyuan City (CN)

(21) Appl. No.: 15/755,769

(22) PCT Filed: Oct. 23, 2015
(86) PCT No.: PCT/CN2015/092745

§ 371 Date: Feb. 27, 2018

(30) Foreign Application Priority Data
Aug. 28, 2015 (CN) 201510540191.5

(51) Int. Cl. G06Q 40/04

(52) U.S. Cl. CPC G06Q 40/04

(57) ABSTRACT

A quantitative trend trade decision-making system based on rick control, which quantifies an investment risk and calculates buying, selling, stop-profit and stop-loss operating points. A decision-making method, which provides a trade instruction on the basis of probabilistic analysis, performs a trial and error process on the trade instruction under a premise of risk control; provides a stop-loss value to a wrong instruction, performs forced liquidation; and provides a stop-profit value to a correct instruction, and provides a quantitative trade or subjective trade. By a quantitative trade model, in a case of profit, the subjective trade may be performed in order to gain the best return. In a case of loss, the trade is strictly performed in accordance with the quantitative decision-making system to minimize a trade risk.

### TECHNICAL FIELD

The present invention belongs to the field of trade decision, and particularly, to a quantitative trend trade decision-making system and method based on risk control.

### BACKGROUND

Quantitative investment is a novel method that has emerged and rapidly developed in the field of international financial investment in recent decades, and is referred to as three main analysis methods together with fundamental analysis and technical analysis. The latter two may be regarded as the traditional security analysis theory, and the quantitative investment is a brand-new analysis method implemented in conjunction with the modern mathematics-probability-statistics theory and the financial data analysis project by utilizing a high-speed computer data processing capacity, which is a modern analysis method.

Compared with the traditional analysis methods, the quantitative trade decision-making system has the most important characteristics of quantification and precision, and has definite buying and selling time points. A trade behavior is more based on computer analysis of a price trend and related factors, rather than human subjective judgment, thereby avoiding influences on trade decisions due to human emotional fluctuation, greed or fear, or even blind faith in rumors, credulity on the so-called inside information.

At present, the quantitative trade systems are roughly divided into two categories. The first one is a high-frequency trade mode, this mode is extremely dependent on the high-speed processing capacity of a computer and the trade interface processing capacity of a trader, and tries to gain meager profit opportunities during random changes in price; and meager profits add up to achieve the profit. However, there is a problem as follows: even if the meager profit opportunities are gained 99 times, once one trade fails, the loss exposure is enlarged, that is, the total profit may be taken or the substantial loss is caused, and high service charge brought by a high-frequency trade is not a small loss for an investor. The second one is a quantitative trend trade mode, because there will be a random reverse fluctuation in a trend, the system mostly puts a research starting point on as much as possible collection and analysis of various data influencing the price, that is, it is possible to find a nearly confirmed decision-making point to predict the next trend of the price. However, as a result, unnecessary data processing content and time are firstly increased, and decision-making opportunities are delayed, in this way, the market often has no chance when the opportunity is confirmed; and secondly, there are too many data factors affecting the trend of the price and large processing amount, which causes a result that parameters are required to be constantly amended and adjusted, and such an amendment is in turn based on subjective empirical values, which deviates from the objectivity of quantitative trade decisions, and further affects the effectiveness of the investment.

Quantitative analysis has many advantages over the traditional analysis method, but is not a substitute for the traditional analysis or subjective analysis for solving all the trade decision-making problems. This is a big misunderstanding. Since there is no perfect trade algorithm, the trend of the price is coming out, not predicted. A mathematical model frequently generates many error signals, i.e. data noises, near a critical value. It is necessary to choose these signals by means of subjective human intervention. However, such an intervention must be very simple and clear, as opposed to constant adjustment of the parameters. Therefore, the reliance on the quantitative model for a complete programmatic trade is also not effective. However, how to clearly define when to use the quantitative trade decisions and when to use a subjective analysis method has become a big challenge in the real investment trade decision.

Accordingly, while there are a variety of trade decision analysis methods at present, due to the concept of research and development and the cognitive bias of implementation techniques, there is few quantitative trade decision-making programs which may actually realize that buying and selling points are immediately given within a trade time, both objectively control the trade risk and subjectively acquire the reasonable maximum return, and achieve the sustainable and stable profit, such that the investor readily places trust in rumors and blindly performs the trade due to the lack of an auxiliary trade tool, resulting in big losses.

### SUMMARY

In order to solve the above problems, the present invention provides a quantitative trend trade decision-making system based on risk control, which quantifies an investment risk and calculates buying, selling, stop-profit and stop-loss operating points.

Further, the decision-making system includes an input module, a processing module, a decision-making module and an output module, wherein the processing module includes a risk control calculation unit and a trade calculation unit; and one end of the processing module is connected to the input module, and the other end is connected to the output module through the decision-making module.

Further, the risk control calculation unit includes a risk control model:

Risk=Co·T·V·Ra·Pr

wherein Co is a trade cost price;

T is a trend duration after the trade is successful;

V is a risk value of a holding period after the trade is successful;

Ra is a price fluctuating range within the holding period after the trade is successful;

Pr is a stop-profit value of the holding period after the trade is successful;

further, the risk control unit performs mock trade through a risk control model; after the trade is successful, the input module inputs the trade cost price, the trend duration after the trade is successful, the risk value of the holding period after the trade is successful, the price fluctuating range within the holding period after the trade is successful, and the stop-profit value of the holding period after the trade is successful into the risk control model; and the risk control model performs a calculation to obtain a risk value of this trade;

the trade calculation unit includes a trade model:

Trade=C·Ma·R·P

wherein C is a closing price;

Ma is a moving average of the closing price;

R is a random fluctuating value of the closing price;

P is a price trend formation probability;

further, after the trade is successful, the input module inputs the closing price, the moving average of the closing price, the random fluctuating value of the closing price and the price trend formation probability into the trade model; and the trade model calculates buying and selling points of an allowed trade of the investor, and the Trade value is a real-time price of the allowed trade.

Further, the decision-making module includes an instruction unit, which obtains a trade time and a trade price according to a Trade algorithm in the trade model.

Further, the decision-making module includes an instruction unit, which obtains buying and selling points, that is, a trade time and a trade price, according to a calculation result of a Trade algorithm in the trade model.

Further, the instruction unit determines a price of the allowed trade according to the Trade value calculated in the trade model, inputs the price into the risk control model, performs a trial and error calculation through the risk control model, that is, a calculation method of a Risk value, and further determines the trade time and the trade price, wherein if the Risk value is negative, the price triggers a stop-loss value, and a stop-loss instruction is issued; and if the Risk value is positive, a quantitative trade is performed, a reasonable stop-profit return is obtained or a subjective trade is performed, so that an optimal stop-profit return is gained.

Further, the input end of the decision-making module is respectively connected to the risk control calculation unit and the trade calculation unit, and the output end of the decision-making module is connected to the output module.

Further, the decision-making system realizes a quantitative trend trade based on a trade platform, the input module is connected to a remote trade platform to obtain data of the trade cost price, the trend duration after the trade is successful, the risk value of the holding period after the trade is successful, the price fluctuating range within the holding period after the trade is successful, and the stop-profit value of the holding period after the trade is successful; the output module is connected to the remote trade platform; and a trade instruction output by the decision-making module is transmitted to the remote trade platform for trade.

Further, all modules and units of the decision-making system are in communication connection.

Further, there is provided a decision-making method, which is based on the decision-making system according to one of claims 1 to 5. The decision-making method provides a trade instruction on the basis of probability analysis, performs a trial and error process on the trade instruction under a premise of a risk control; provides a stop-loss value to a wrong instruction, performs forced liquidation; and provides a stop-profit value to a correct instruction, and provides a quantitative trade or subjective trade.

Further, the decision-making method includes:

S1: according to calculation results of a closing price, a moving average of the closing price, a random fluctuating value of the closing price and a price trend formation probability, Trade=C·Ma·R·P, determining buying and selling points which may be traded by an investor, and issuing a trade instruction;

S2: Risk=Co·T·V·Ra·Pr, calculating according to the trade cost price, the duration, the risk value of the holding period, the price fluctuating range within the holding period and the stop-profit value of the holding period to immediately obtain the risk value of this trade;

S3: determining the Risk value, if the Risk value is negative, entering S4; and if the Risk value is positive, entering S5;

S4: triggering a stop-loss value by the price, and issuing a stop-loss instruction; and

S5: quantifying the trade and obtaining a reasonable stop-profit return or performing a subjective trade to gain an optimal stop-profit return.

The decision-making system of the present invention has the following beneficial effects:

1, by means of the quantitative trade model, precise buying, selling, stop-profit and stop-loss operating points are given, and uncertainty and emotional impacts of the subjective trade are avoided;

2, the risk of a trade failure is effectively controlled, a trend opportunity is captured for performing a non-high frequency trade, stop-profit is dynamically tracked to obtain a reasonable investment return; and a sustainable and stable profit is obtained;

3, an application boundary of a subjective trade and a quantitative trade is defined, that is, in case of profit, a subjective trade may be performed in order to gain an optimal return; in a case of loss, a trade is strictly performed in accordance with the quantitative decision-making system to avoid loss enlargement resulting from the fluke mind; and

4, quantification illustrates the minimum operable rise and fall period, thereby favorably selecting an optimal take-profit or stop-loss settlement time point, namely, favorably selecting an optimal profit-making time point in a case of profit, and avoiding subjective hesitation and missing an optimal stop-loss opportunity in the case of loss

### DESCRITPION OF DRAWINGS

FIG. 1 is a block diagram showing a decision-making system of the present invention; and

FIG. 2 is an operation flowchart of a decision-making method of the present invention.

### DETAILED DESCRIPTION OF EMBODIMENT

Objectives, technical solutions and advantages of the present invention will become more apparent from the following detailed description of the present invention when taken in conjunction with accompanying drawings. It should be understood that specific embodiments described herein are merely illustrative of the present invention and are not intended to limit the present invention.

Rather, the present invention encompasses any alternatives, modifications, equivalents, and solutions made within the spirit and scope of the present invention as defined by the claims. Further, in order to give the public a better understanding of the present invention, some specific details are described below in detail in the following detailed description of the present invention.

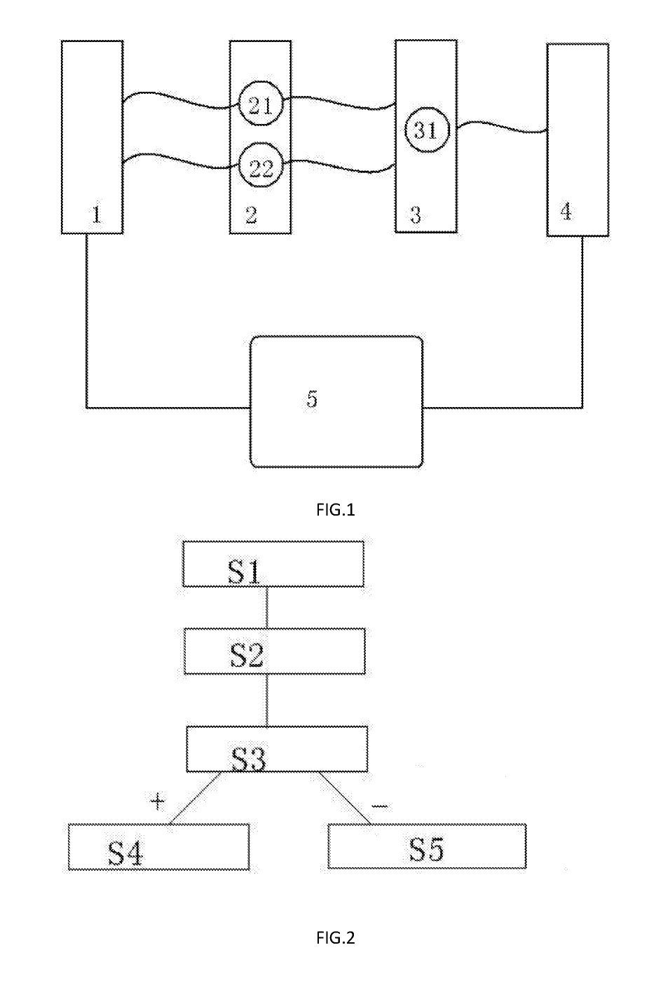

As shown in FIG. 1, FIG. 1 is a block diagram showing a quantitative trend trade decision-making system based on risk control; and FIG. 2 is an operation flowchart of performing decision judgment by a decision-making module 3 of the present invention.

The system includes an input module 1, a processing module 2, a decision-making module 3 and an output module 4.

The input module 1 is connected to the processing module 2.

The processing module 2 includes a risk control calculation unit 21 and a trade calculation unit 22.

The risk control calculation unit 21 includes a risk control model: Risk=CO·T·V·Ra·Pr

wherein Co is a trade cost price;

T is a trend duration after the trade is successful;

V is a risk value of a holding period after the trade is successful;

Ra is a price fluctuating range within the holding period after the trade is successful;

Pr is a stop-profit value of the holding period after the trade is successful;

the input module 1 is connected to the risk control calculation unit 21; after the trade is successful, the input module 1 acquires data from a remote trade platform 5, and transmits the trade cost price, the trend duration after the trade is successful, the risk value of the holding period after the trade is successful, the price fluctuating range within the holding period after the trade is successful, and the stop-profit value of the holding period after the trade is successful to the risk control model; and the risk control model performs a calculation to obtain a risk value of this trade.

The trade calculation unit 22 includes a trade model: Trade=C·Ma·R·P

wherein C is a closing price;

Ma is a moving average of the closing price;

R is a random fluctuating value of the closing price;

P is a price trend formation probability;

the input module 1 is connected to the trade calculation unit 22; after the trade is successful, the input module 1 acquires data from the remote trade platform 5, and inputs the closing price, the moving average of the closing price, the random fluctuating value of the closing price and the price trend formation probability into the trade model; and the trade model calculates buying and selling points of an allowed trade of the investor, that is, a trade time and a trade amount which may be traded.

An input end of the decision-making module 3 is respectively connected to the risk control calculation unit 21 and the trade calculation unit 22, an output end of the decision-making module 3 is connected to the output module 4, the decision-making module 3 includes an instruction unit 31, the instruction unit 31 obtains a real-time tradable time and a trade price according to a Trade algorithm in the trade model; the instruction unit 31 further determines the trade time and the trade price according to the judgment of the Risk value calculated in the risk control model, so as to achieve that in a case of a trial and error process, a failure risk is controlled and a trade event is completed; if the Risk value is negative, when the trade price reaches a stop-loss value, a stop-loss instruction is issued; and if the Risk value is positive, then the risk control model will follow a price trend, and generates a stop-profit value Pr in real time by calculating the price fluctuating range within the holding period; after a real price triggers the stop-profit value, the system issues a stop-profit signal to ensure that the trade makes a reasonable profit; and meanwhile, if the Risk value is positive, a subjective selling trade may be performed in accordance with the experience of the investor.

One end of the output module 3 is connected to the instruction unit 31 to receive a trade instruction sent by the decision-making module 3, and the other end of the output module 3 is connected to the remote trade platform 5 to execute a trade behavior.

All modules and units are in communication connection.

The input module 1 acquires trade real-time information from the remote trade platform 5, arranges and transmit the trade real-time information to the processing module 2, and the processing module 2 substitutes the trade real-time information into the trade model and the risk control model and calculates buying and selling points by utilizing the Trade algorithm. For example, before the trade, the closing price is 18 yuan, the moving average of the closing price is an average closing price calculated in conjunction with the previous time, the moving average of the closing price is 17.5 yuan, the random fluctuating value of the closing price is 20%-28%, the price trend formation probability is 25%, then this tradable price is 17.5×18×20%×25%—17.5×18×28%×25%, and the tradable price is between 15.75 yuan and 22.05 yuan. During the trade with this price, a trial and error instruction is executed and a real-time risk value is calculated by utilizing the Risk algorithm, Risk=Risk=CO·T·V·Ra·Pr, the trade cost price is 18 yuan, the trend duration after the trade is successful is 1 day/period, the risk value of the holding period after the trade is successful is 80%, the price fluctuating range within the holding period after the trade is successful is the above 15.75 yuan-22.05 yuan, and the stop-profit value of the holding period after the trade is successful is within an interval of 15.71−18=−2.29 yuan and 22.05−18=4.05 yuan, accordingly, before the price is 18 yuan, if the Risk value is negative, forced liquidation is performed; and if the Risk value is positive, two options are provided, the trade may be performed at a stop-profit point, and may be determined according to personal experiences.

After completing the trade, the input module 3 acquires information from the remote trade platform 5 again, and so on, such that the trade is within the decision-making system at any time.

Although the embodiment of the present invention has been shown and described, it will be understood by those skilled in the art that various changes, modifications, substitutions and variations may be made to these embodiments without departing from the principle and purpose of the present invention, and the scope of the present invention is defined by claims and their equivalents.

1-10 (canceled)

11. A quantitative trend trade decision-making system based on risk control, which quantifies an investment risk and calculates buying, selling, stop-profit and stop-loss operating points.

12. The decision-making system according to claim 11, comprising an input module, a processing module, a decision-making module and an output module, wherein the processing module comprises a risk control calculation unit and a trade calculation unit; and one end of the processing module is connected to the input module, and the other end is connected to the output module through the decision-making module.

13. The decision-making system according to claim 12, wherein the risk control calculation unit comprises a risk control model:
Risk=Co·T·V·Ra·Pr
wherein Co is a trade cost price;
T is a trend duration after the trade is successful;
V is a risk value of a holding period after the trade is successful;
Ra is a price fluctuating range within the holding period after the trade is successful;
Pr is a stop-profit value of the holding period after the trade is successful;
wherein, the risk control unit performs mock trade through a risk control model; after the trade is successful, the input module inputs the trade cost price, the trend duration after the trade is successful, the risk value of the holding period after the trade is successful, the price fluctuating range within the holding period after the trade is successful, and the stop-profit value of the holding period after the trade is successful into the risk control model; and the risk control model performs a calculation to obtain a risk value of this trade;
the trade calculation unit comprises a trade model:
Trade=C·Ma·R·P
wherein C is a closing price;
Ma is a moving average of the closing price;
R is a random fluctuating value of the closing price;
P is a price trend formation probability;
wherein, after the trade is successful, the input module inputs the closing price, the moving average of the closing price, the random fluctuating value of the closing price and the price trend formation probability into the trade model; and the trade model calculates buying and selling points of an allowed trade of the investor, and the Trade value is a real-time price of the allowed trade.

14. The decision-making system according to claim 12, wherein the decision-making module comprises an instruction unit, which obtains buying and selling points, that is, a trade time and a trade price, according to a calculation result of a Trade algorithm in the trade model.

15. The decision-making system according to claim 14, wherein the instruction unit determines a price of the allowed trade according to the Trade value calculated in the trade model, inputs the price into the risk control model, performs a trial and error calculation through the risk control model, that is, a calculation method of a Risk value, and further determines the trade time and the trade price, wherein if the Risk value is negative, the price triggers a stop-loss value, and a stop-loss instruction is issued; and if the Risk value is positive, a quantitative trade is performed, a reasonable stop-profit return is obtained or a subjective trade is performed, so that an optimal stop-profit return is gained.

16. The decision-making system according to claim 13, wherein the input end of the decision-making module is respectively connected to the risk control calculation unit and the trade calculation unit, and the output end of the decision-making module is connected to the output module.

17. The decision-making system according to claim 11, wherein the decision-making system realizes a quantitative trend trade based on a trade platform, the input module is connected to a remote trade platform to obtain data of the trade cost price, the trend duration after the trade is successful, the risk value of the holding period after the trade is successful, the price fluctuating range within the holding period after the trade is successful, and the stop-profit value of the holding period after the trade is successful; the output module is connected to the remote trade platform; and a trade instruction output by the decision-making module is transmitted to the remote trade platform for trade.

18. The decision-making system according to claim 11, wherein all modules and units of the decision-making system are in communication connection.

19. A decision-making method based on the decision-making system according to claim 11, characterized by providing a trade instruction on the basis of probability analysis, performing a trial and error process on the trade instruction under a premise of a risk control; providing a stop-loss value to a wrong instruction, performing forced liquidation; providing a stop-profit value to a correct instruction, and providing a quantitative trade or subjective trade.

20. The decision-making method according to claim 19, comprising:
S1: according to calculation results of a closing price, a moving average of the closing price, a random fluctuating value of the closing price and a price trend formation probability, Trade=C·Ma·R·P, determining buying and selling points which may be traded by an investor, and issuing a trade instruction;
S2: Risk=Co·T·V·Ra·Pr, calculating according to the trade cost price, the duration, the risk value of the holding period, the price fluctuating range within the holding period and the stop-profit value of the holding period to obtain a risk value of this trade;
S3: determining the Risk value, if the Risk value is negative, entering S4; and if the Risk value is positive, entering S5;
S4: triggering a stop-loss value by the price, and issuing a stop-loss instruction; and
S5: quantifying the trade and obtaining a reasonable stop-profit return or performing a subjective trade in order to gain an optimal stop-profit return.
